(19) United States
(12) Patent Application Publication
(10) Pub. No.: US 2002/0108563 A1
(43) Pub. Date: Aug. 15, 2002

(54) Coating device and coating method

(76) Inventor: Yuko Yoshida, Sagaminara-city (JP)

Correspondence Address: Attention: Brian E. Szymanski, Office of Intellectual Property Counsel, 3M Innovative Properties Company, P.O. Box 33427, St. Paul, MN, 55133-3427, US

(21) Appl. No.: 10/077,567

(22) Filed: Feb. 15, 2002

(30) Foreign Application Priority Data
Feb. 15, 2001 (JP) 2001-38550

(51) Int. Cl. B05C 11/00

(52) U.S. Cl. 118/76; 118/224; 118/249; 118/244

(57) ABSTRACT

A coating device is provided, in which a coating layer of uniform thickness can be steadily formed with high accuracy over a long time on the surface of a base-web material without being affected by the thickness irregularities of the base-web material itself.

This application is claiming priority under 35 U.S.C. Section 119 to Japanese Application No. 2001-38550 filed on Feb. 15, 2001, herein incorporated by reference in its entirety. The present invention relates to coating device and method for forming a coating layer continuously on the surface of a running base-web material.

### Technical Field of the Invention

### Background of The Invention

A reverse roll coating method is known as a method for coating a fluid coating material of the desired viscosity on the surface of a base-web material having a continuous length and a predetermined width such as a resin film, a resin sheet or paper. A coating device for implementing the reverse roll coating method is generally configured with a backing roll rotated carrying a running base-web material on the outer peripheral surface thereof, an application roll arranged in parallel proximity to the backing roll and rotated in the same direction as the backing roll while at the same time bringing the outer peripheral surface thereof into contact with the base-web material running along the backing roll, and a coating material supply section for supplying coating material on the outer peripheral surface of the application roll. In this coating device, the surface of the base-web material running along the backing roll in rotation and the outer peripheral surface of the application roll in rotation move in opposite directions at the mutual contact point thereof As a result, the coating material continuously supplied from the coating material supply section to the outer peripheral surface of the application roll in rotation is transferred to and spread on the surface of the running base-web material, so that a coating layer of the desired thickness is continuously formed on the surface of the base-web material.

With such a configuration as described above, a coating layer of uniform thickness corresponding to the amount of the coating material supplied to the application roll from the coating material supply section can be formed on the surface of the base-web material by stabilizing the amount of the coating material thus supplied. For this purpose, the conventional reverse roll coating device is generally equipped with a doctor knife and a doctor roll for supplying an equal amount of coating material to the outer peripheral surface of the application roll. Also, the thickness of the coating layer formed on the surface of the base-web material can be controlled by the ratio of the speed of the outer peripheral surface (tangential speed) between the application roll and the backing roll, the interval between the outer peripheral surfaces of the two rolls and the pressure exerted on the base-web material from the two rolls.

In this case, the thickness of the coating layer may be affected by the vibration which may be caused in the base-web material due to the movement in opposite directions of the outer peripheral surface of the application roll and the surface of the base-web material at the mutual contact point between the two surfaces when coating material is transferred from the former surface to the latter surface. In order to obviate this possibility, the reverse roll coating device is generally so configured that the base-web material is wound on the outer peripheral surface of the backing roll over a sufficiently long distance to eliminate the possible vibrations of the base-web material downstream of the mutual contact point between the surface of the base-web material and the outer peripheral surface of the application roll in the direction of web run. By doing so, in the conventional reverse roll coating device, the vibration of the base-web material is effectively eliminated to steadily secure a uniform thickness of the coating layer. Also, this configuration broadens the peripheral space at the coating material transfer point where coating material is transferred from the outer peripheral surface of the application roll to the surface of the base-web material, so that the pressure exerted on the coating material at the coating material transfer point is substantially released into the surrounding atmosphere. Even in the case where the base-web material has irregular thickness, therefore, a uniform thickness of the coating layer can be secured without being affected by the irregular thickness.

### Problems To Be Solved by the Invention

With the configuration of the conventional reverse roll coating device described above, the peripheral space at the coating material transfer point between the application roll and the base-web material is so broad that with the increase in the amount of coating material supplied to the application roll, the portion of the coating material flowing at the coating material transfer point increases and the meniscus thereof is easily expanded. An excessive meniscus of the flowing coating material portion at the coating material transfer point easily causes a local convection in the flowing coating material portion with the travel of the base-web material. The local convection, if any is caused, in the flowing coating material portion tends to generate a rib-shaped bulge extending continuously longitudinally of the web on the surface of the coating layer on the base-web material corresponding to the position of the convection. In the conventional reverse roll coating device, therefore, a comparatively thick coating layer of, say, over several μm is generally difficult to form with high accuracy, depending on the properties such as the viscosity and the surface tension of the coating material.

Also, in the conventional reverse roll coating device, with the increase in the amount of coating material supplied to the application roll, the dimensional accuracy and the positional accuracy of the doctor knife and the doctor roll provided in the coating material supply section have a greater effect on the amount of coating material supplied, thereby often making it difficult to accurately control the amount of coating material supplied. As a result, it is also still generally difficult to form a comparatively thick coating layer with high accuracy.

Incidentally, what is called a die coating method is known as another coating method capable of securing a uniform coating layer thickness with high accuracy. In the die coating method, a coating layer of the desired thickness is formed by continuously extruding a fluid coating material of the desired viscosity from a coating head constituted of the nozzle portion of an extrusion die onto the surface of a running base-web material. In a coating device for implementing the die coating method of this category, the coating material extruded from the coating head is pressured and measured while flowing through a minuscule gap (generally called the coating gap) formed between the nozzle end face of the coating head and the surface of the base-web material. As a result, a coating layer of predetermined thickness is continuously formed on the surface of the running base-web material.

In the die coating device, therefore, unlike the reverse roll coating device described above, the thickness of the coating layer can be directly controlled by adjusting the dimension of the coating gap and the amount of coating material supplied by extrusion from the coating head. Thus, a coating layer of uniform thickness, large or small, can be steadily formed with high accuracy over a long time on the surface of the base-web material. In the case where the base-web material itself has irregular thickness, however, the dimension of the coating gap tends to change accordingly thereby adversely affecting the uniformity of the thickness of the coating layer. The effect that the irregular thickness of the base-web material has on the uniformity of the coating layer thickness becomes more conspicuous with the decrease in the thickness of the coating layer to be formed.

The present invention provides a coating device for forming a coating layer continuously on the surface of a running base-web material, in which a coating layer of uniform thickness can be steadily formed with high accuracy regardless of the magnitude of the required coating layer thickness, without being substantially affected by the irregular thickness which the base-web material may have.

The present invention also provides a coating method for forming a coating layer continuously on the surface of a running base-web material, in which a coating layer of uniform thickness can be steadily formed with high accuracy regardless of the magnitude of the required coating layer thickness, without being substantially affected by the irregular thickness which the base-web material may have.

### Means for Solving the Problems

The invention defined in claim 1 provides a coating device for continuously forming a coating layer on a surface of a running base-web materials comprising: a backing roll rotatable while carrying on an outer surface thereof a running base-web material; an application roll arranged close and parallel to the backing roll and rotatable in the same direction as a rotating direction of the backing roll while coming into contact on an outer surface thereof with the base-web material running along the backing roll; a coating material supply section for supplying a coating material on the outer surface of the application roll; and a separating section arranged downstream of said backing roll and said application roll as seen in a web running direction, said separating section capable of separating the running base-web material from said outer surface of said backing roll at a position inside a mutually opposed region of said backing roll and said application roll; wherein the coating material continuously supplied from the coating material supply section to the outer surface of the rotating application roll is transferred to a surface of the running base-web material so as to continuously form a coating layer with a predetermined thickness.

The invention defined in claim 2 provides a coating device, as set forth in claim 1, wherein said separating section acts to direct the base-web material in a direction generally orthogonal to a virtual plane involving a rotation axis of said backing roll and a rotation axis of said application roll.

The invention defined in claim 3 provides a coating device, as set forth in claim 1 or 2, wherein said separating section includes a running-angle adjusting mechanism for adjusting a running angle of the base-web material relative to a virtual plane involving a rotation axis of said backing roll and a rotation axis of said application roll.

The invention defined in claim 4 provides a coating device, as set forth in claim 3, wherein said separating section includes a take-off roll arranged parallel to said backing roll and rotatable while carrying on an outer surface thereof the running base-web material, and wherein said running-angle adjusting mechanism acts to move said take-off roll while maintaining a parallelism thereof so as to adjust the running angle of the base-web material.

The invention defined in claim 5 provides a coating device further comprising a damping section arranged between said backing roll and said separating section, said damping section capable of coming into contact with the running base-web material to damp a vibration of said base-web material.

The invention defined in claim 6 provides a coating device, as set forth in claim 5, wherein said damping section includes a touch roll arranged parallel to said backing roll and rotatable while touching the running base-web material.

The invention defined in claim 7 provides a coating device further comprising a pressure adjusting mechanism for adjusting a pressure applied to the base-web material from said backing roll and said application roll at a location between said backing roll and said application roll.

The invention defined in claim 8 provides a coating device, as set forth in claim 7, wherein said pressure adjusting mechanism includes a tension monitoring section for monitoring a tension applied longitudinally on the base-web material at a downstream side of said backing roll and said application roll as seen in a web running direction, and a roll, position adjusting section for adjusting a relative position of said backing roll to said application roll so as to correspond to a fluctuation of the tension monitored by said tension monitoring section.

The invention defined in claim 9 provides a coating device further comprising a backing roll moving mechanism for moving said rotating backing roll relative to said rotating application roll while maintaining a parallelism thereof.

The invention defined in claim 10 provides a coating device further comprising a driving section arranged downstream of said backing roll and said application roll as seen in a web running direction and causing the base-web material to run in a longitudinal direction thereof at a predetermined speed, and a nip roll arranged upstream of said backing roll and said application roll as seen in a web running direction and rotatable while holding the base-web material running due to an operation of said driving section between said nip roll and said backing roll.

The invention defined in claim 11 provides a coating device wherein said coating material supply section comprises a die nozzle which includes a nozzle end face opposed to said outer surface of said application roll and a supply passage communicating with said nozzle end face to continuously supply a coating material in an extruding manner on said nozzle end face through said supply passage, and wherein the coating material is measured between said outer surface of said rotating application roll and said nozzle end face of said die nozzle, so as to be continuously supplied in the form of a coating layer with a predetermined thickness on said outer surface of said application roll.

The invention defined in claim 12 provides a coating device, as set forth in claim 11, wherein said die nozzle includes in an integral manner a first portion involving at least said nozzle end face and a second portion adjacent to said first portion, said first portion being made of a material with a coefficient of thermal expansion different from that of a material of said second portion.

The invention defined in claim 13 provides a coating device wherein said nozzle end face of said die nozzle is located closest to said outer surface of said application roll at a predetermined position inside a surface area defined between a downstream end as seen in an application-roll rotating direction and said supply passage.

The invention defined in claim 14 provides a coating method comprising: having a base-web material carried on an outer surface of a rotatable backing roll; arranging a rotatable application roll close and parallel to the backing roll so as to come into contact on an outer surface of the application roll with the base-web material carried on the backing roll; having the base-web material run continuously in one direction so as to rotate the backing roll in one direction; separating the running base-web material from he outer surface of the backing roll at a position inside a mutually opposed region of the backing roll and the application roll; rotating the application roll in the same direction as a rotating direction of the backing roll; and continuously supplying a coating material on the outer surface of the rotating application roll, so that the coating material is transferred to a surface of the running base-web material so as to continuously form a coating layer with a predetermined thickness on the surface.

The invention defined in claim 15 provides a coating method, as set forth in claim 14, further comprising a step of having the running base-web material brought into contact with an object at a location downstream of the backing roll as seen in a web running direction, so as to damp a vibration of the base-web material.

The invention defined in claim 16 provides a coating device for continuously forming a coating layer on a surface of a running base-web material, comprising: a backing roll rotatable while carrying on an outer surface thereof a running base-web material, an application roll arranged close and parallel to the backing roll and rotatable in the same direction as a rotating direction of the backing roll while coming into contact on an outer surface thereof with the base-web material running along the backing roll, and a die nozzle including a nozzle end face opposed to said outer surface of said application roll and a supply passage communicating with said nozzle end face to continuously supply a coating material in an extruding manner on said nozzle end face through said supply passage; wherein the coating material is measured between said outer surface of said rotating application roll and said nozzle end face of said die nozzle, so as to be continuously supplied in the form of a coating layer with a predetermined thickness on said outer surface of said application roll; and wherein the coating material supplied to the outer surface of the application roll is transferred to a surface of the running base-web material so as to continuously form a coating layer with a predetermined thickness.

### BIRIEF DESCRIPTION OF THE DRAWINGS

FIG. 1 is a front view showing a configuration of a coating device in the process of coat work on a base-web material according to an embodiment of the invention.

FIG. 2 is a partly enlarged view showing the manner in which the coat work is conducted in the coating device of FIG. 1.

FIG. 3 is a partly enlarged view showing the manner in which coating material is supplied in the coating device of FIG. 1.

FIG. 4 is a side view schematically showing a configuration of the coating device of FIG. 1.

FIG. 5 is a flowchart showing the pressure adjusting process in the coating device of FIG. 1.

FIG. 6 is a partly enlarged view showing one of the optimum manners in which the coat work is conducted in the coating device of FIG. 1 not showing the damping section.

FIG. 7 is a diagram corresponding to FIG. 6 showing a deteriorated coat work condition.

FIG. 8 is a diagram corresponding to FIG. 7 showing an optimized coat work condition.

FIG. 9 is a diagram for explaining the operation of the coating device of FIG. 1 during the passage of a web joint, in which (a) shows the normal coat work and (b) the coat work suspension.

FIG. 10 is a partly enlarged view showing a modification of the coating material supply section of the coating device of FIG. 1.

FIG. 11 is a partly enlarged view showing another modification of the coating material supply section of the coating device of FIG. 1.

### DETAILED DESCRIPTION

Embodiments of the present invention will be explained in detail below with reference to the accompanying drawings. In the drawings, the same or similar component elements are designated by common reference numerals, respectively.

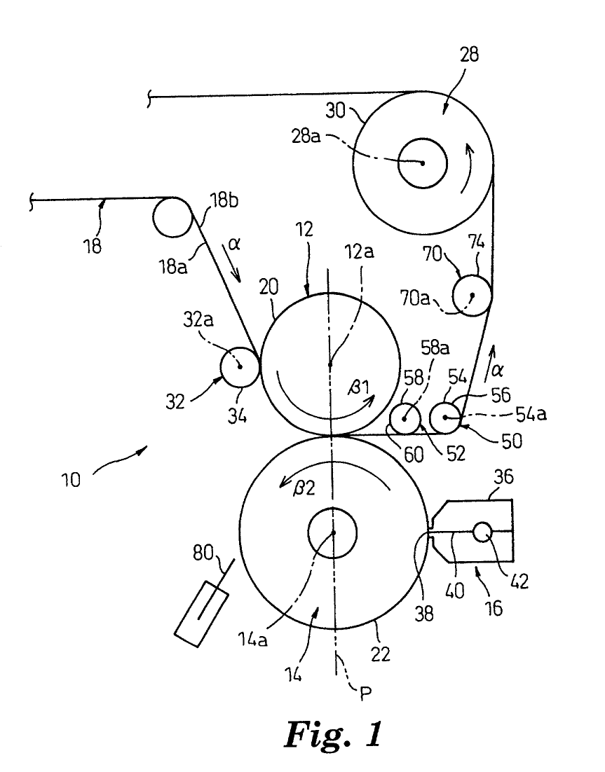

By referring to the drawing, FIG. 1 is a front view schematically showing a coating device 10 according to an embodiment of the invention. The coating device 10 is configured with a backing roll 12 rotatable about an axis 12a, an application roll 14 having an axis 14a parallel to the axis 12a of the backing roll 12, arranged in proximity and parallel to the backing roll 12 and rotatable about the axis 14a, and a coating material supply section 16 for supplying coating material to the application roll 14.

A base-web material 18 such as a resin film, a resin sheet or paper having a continuous length and a predetermined width is supplied to the backing roll 12 from a web storage section not shown, and by winding a predetermined range of the cylindrical outer peripheral surface 20 of the backing roll 12, runs continuously at a predetermined speed in the direction α of the shown arrow by being driven by a web feed drive section described later. At the same time, the backing roll 12 rotates smoothly in the direction of shown arrow β following the travel of the base-web material 18 with the outer peripheral surface 20 thereof carrying in close contact with one of the surfaces (hereinafter referred to as the reverse surface 18b) of the base-web material 18. In this configuration, a drive source for rotationally driving the backing roll 12 directly is not included.

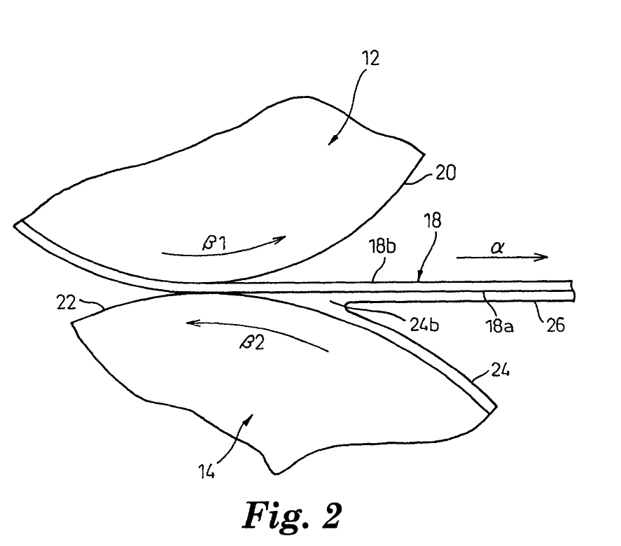

The application roll 14 is driven by a drive source not shown such as an electric motor and rotated in the same direction β2 as the rotational direction β1 of the backing roll 12. In the process, the application roll 14 has the cylindrical outer peripheral surface 22 thereof in contact with the other surface (hereinafter referred to as the front surface 18a) of the base-web material 18 running along the backing roll 12. As shown in FIG. 2 in enlarged form, therefore, the front surface 18a of the base-web material 18 running in the direction α along the backing roll 12 rotating in the direction β1 and the outer peripheral surface 22 of the application roll 14 rotating in the direction β2 move in opposite directions at the mutual contact point. As a result, the coating material 24 supplied continuously from the coating material supply section 16 to the outer peripheral surface 22 of the rotating application roll 14 is transferred to and spread on the front surface 18a of the running base-web material 18, thereby forming a coating layer 26 of the desired thickness continuously on the front surface 18a of the base-web material 18.

A web feed drive section constituted of a drive roll 28 connected to a drive source not shown such as an electric motor is arranged with the axis 28a thereof directed in parallel to the axis 12a of the backing roll 12 downstream of the backing roll 12 and the application roll 14 in the direction of web run. The drive roll 28 is rotated at a predetermined speed by being driven by the drive source with a predetermined range of the cylindrical outer peripheral surface 30 thereof wound with the reverse surface 18b of the base-web material 18 in contact therewith, so that the base-web material 18 is fed constantly at a predetermined speed in the longitudinal direction.

Also, a nip roll 32 having a rotation axis 32a parallel to the axis 12a of the backing roll 12 is arranged in proximity to the backing roll 12 upstream of the backing roll 12 and the application roll 14 in the direction of web run. The base-web material 18 run by being driven by the drive roll 28 is held closely between the cylindrical outer peripheral surface 34 of the nip roll 32 and the outer peripheral surface 20 of the backing roll 12. Under this condition, the nip roll 32 rotates smoothly following the feed of the base-web material 18. The nip roll 32 functions to keep the reverse surface 18b of the base-web material 18 in close contact with the outer peripheral surface 20 of the backing roll 12, while at the same time preventing the tension imposed longitudinally of the base-web material 18 and the change of the particular tension upstream of the nip roll 32 from being transmitted to the base-web material portion located downstream of the nip roll 32.

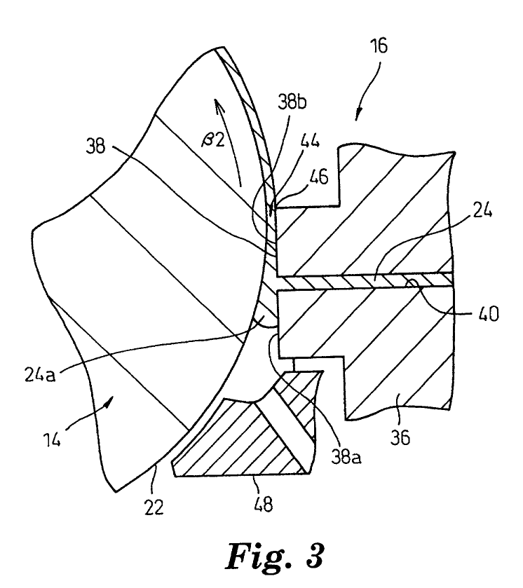

The coating material supply section 16 includes a die nozzle 36 capable of highly accurately controlling the amount of the coating material supplied to the application roll 14. As shown in FIG. 3 in enlarged form, the die nozzle 36 includes a flat nozzle end face 38 opposed to the outer peripheral surface 22 of the application roll 14 and a coating material supply passage 40 communicating with the nozzle end face 38. The die nozzle 36 is supplied with a fluid coating material 24 of the desired viscosity continuously through a pump not shown from an external storage tank not shown. The coating material 24 supplied to the die nozzle 36 is extruded continuously under pressure onto the nozzle end face 38 through the coating material supply passage 40 in accordance with a set flow rate of the pump.

The coating material supply passage 40 extends transversely substantially at right angles to the rotational direction β2 of the application roll 14 (i.e. along the direction of the axis of the application roll 14) and opens to the nozzle end face 38. Also, a tubular enlarged flow passage portion 42 extending transversely is similarly arranged at the upstream end of the coating material supply passage 40 (FIG. 1). The coating material 24 supplied from an external storage tank to the coating material supply passage 40 flows into the coating material supply passage 40 after first expanding uniformly transversely of the enlarged flow passage portion 42. As a result, the pressure and the flow rate distribution of the coating material 24 flowing in the coating material supply passage 40 are equalized over the whole coating material supply passage 40.

The nozzle end face 38 of the die nozzle 36 is divided, on both sides of the opening of the coating material supply passage 40, into a first surface portion 38a located upstream and a second surface portion 38b located downstream as viewed in the rotational direction β2 of the application roll. The coating material 24 extruded on the nozzle end face 38 is pressured and measured while flowing through a wedge-shaped minuscule gap 44 (hereinafter referred to as the coating material work gap 44) formed mainly between the second surface portion 38b and the outer peripheral surface 22 of the application roll 14. As a result, the die nozzle 36 supplies the coating material 24 continuously on the outer peripheral surface 22 of the rotating application roll 14 in the form of a wet coating layer band having a predetermined width and a uniform thickness both transversely (along the direction of axis of the application roll) and longitudinally (along the rotational direction of the application roll).

As described above, in the coating device 10, the coating material supply section 16 is equipped with the die nozzle 36, and therefore the coating material 24 accurately measured in the coating work gap 44 can be supplied with high accuracy on the outer peripheral surface 22 of the application roll 14 in the form of a wet coating layer having a uniform thickness. The amount of the coating material 24 supplied to the application roll 14, i.e. the film thickness can be controlled with high accuracy by adjusting the amount of the coating material 24 extruded by the die nozzle 36 and also by adjusting the interval between the nozzle end face 38 of the die nozzle 36 and the outer peripheral surface 22 of the application roll 14 at the same time.

The downstream end 46 of the second surface portion 38b of the nozzle end face 38 (hereinafter referred to as the die lip 46) is formed as a sharp edge with a very high straightness in order to smooth with high accuracy the surface of the coating layer formed on the outer peripheral surface 22 of the application roll 14. Also, in order to maintain the required high level of accuracy of the amount of the coating material 24 supplied to the application roll 14, i.e. the film thickness, the outer peripheral surface 22 of the application roll 14 is formed into a cylindrical surface of high cylindricity and roundness, for example, to the smoothness of Ra<1.0 μm in surface roughness by high-precision machining. At the same time, the run-out of the application roll 14 in rotation is suppressed as far as possible by improving the machining and assembly accuracy of the component parts. These factors determining the accuracy of the coating gap 44 are required to meet the conditions of the following equation.

Tolerance of coating gap 44 =Σ(straightness error of die lip 46, cylindricity error of application roll 14, run-out of application roll 14, etc.) ≦2× (thickness tolerance of wet film supplied to application roll 14)

Also, the die nozzle 36 can be equipped with a pressure reducing device 48 for reducing the pressure in the space between the first surface portion 38a and the outer peripheral surface 22 of the application roll 14 adjacently to the first surface portion 38a of the nozzle end face 38. The pressure reducing device 48 is activated while the coating material 24 is being supplied to the application roll 14, and operates in such a manner as to assure an ideal bead shape of the fluid portion 24a of the coating material 24 formed between the first surface portion 38a of the nozzle end face 38 and the outer peripheral surface 22 of the application roll 14. Once the fluid portion 24a of the coating material 24 being supplied to the application roll 14 is steadily maintained in an ideal shape, the thickness accuracy of the film formed on the outer peripheral surface 22 of the application roll 14 is further improved.

In the coating device 10, as described above, the coating material 24 of which the amount supplied is controlled with high accuracy is accurately transferred to the base-web material 18 from the application roll 14, so that the coating layer 26 of a very superior quality (uniform thickness, smooth surface and absence of defects) is formed on the surface 18a of the base-web material 18. In order to realize this high-accuracy coat work and form the coating layer 26 having a comparatively large thickness range of several μm to several tens of μm by controlling the film thickness with high accuracy, the coating device 10 further employs the configuration features described below.

Referring to FIG. 1 again, the coating device 10 comprises a separating section 50 arranged downstream of the backing roll 12 and the application roll 14 in the direction of web run. The separating section 50 operates in such a manner that the base-web material 18 running along the backing roll 12 is separated from the outer peripheral surface 20 of the backing roll 12 within a mutually opposed area in which the outer peripheral surface 20 of the backing roll 12 is located in opposed proximity to the outer peripheral surface 22 of the application roll 14. Further, the coating device 10 comprises a damping section 52 arranged between the backing roll 12 and the separating section 50. The damping section 52 operates to dampen the vibration of the base-web material 18 by contacting the base web material 18 running from the backing roll 12 toward the separating section 50.

In the conventional ordinary reverse roll coating device, as described above, the base-web material is wound on the outer peripheral surface of the backing roll over a sufficiently long length downstream of the mutual contact point between the base-web material and the application roll in the direction of web run in order to prevent the vibration which may occur in the base-web material when the coating material is transferred from the application roll. In view of the wide peripheral space at the coating material transfer point between the application roll and the base-web material, an increased amount of the coating material supplied tends to generate a rib-shaped bulge extending continuously on the surface of the coating layer on the base-web material longitudinally of the base-web material.

In the coating device 10 according to the invention, in contrast, the separating section 50 separates the base-web material 18 from the outer peripheral surface 20 of the backing roll 12 within the mutually opposed area between the backing roll 12 and the application roll 14, so that the peripheral space at the coating material transfer point between the application roll 14 and the base-web material 18 is narrowed thereby to reduce and stabilize the meniscus of the fluid portion 24b (FIG. 2) of the coating material 24 flowing at the coating material transfer point. As a result, even in the case where the volume of the fluid portion 24b of the coating material 24 increases with the increase in the amount of coating material supplied to the application roll 14, the enlargement of the meniscus is suppressed. In this way, it is possible to effectively prevent the occurrence of the local convection which otherwise might be caused in the coating material fluid portion 24b by the running base-web material 18 and the resulting possible generation of the rib-shaped defect on the coating layer surface.

Due to this operation of the separating section 50, the length by which the base-web material 18 is wound on the outer peripheral surface 20 of the backing roll 12 downstream of the mutual contact point between the base-web material 18 and the application roll 14 in the direction of web run is considerably reduced, or desirably reduced to zero, as compared with the corresponding length for the conventional reverse roll coating device. As a result, the running base-web material 18 may be liable to vibrate. Nevertheless, the damping section 52 operates to attenuate the vibration effectively, thereby making it possible to eliminate the effect on the uniformity of the thickness of the coating layer 26 formed on the base-web material 18. It should be noted that the damping section 52 may be omitted, if the vibration generated in the running base-web material 18 does not affect the desired accuracy of the coating layer even when the separating section 50 is operating to separate the base-web material.

According to the shown embodiment, the separating section 50 includes a take-off roll 54 having a rotation axis 54a parallel to the axis 12a of the backing roll 12. The takeoff roll 54 is arranged between the backing roll 12 and a drive roll 28 and carries the reverse surface 18b of the running base-web material 18 wound on a part of the cylindrical outer peripheral surface 56. Thus, the take-off roll 54 separates the base-web material 18 from the outer peripheral surface 20 of the backing roll 12 within the mutually opposed area between the backing roll 12 and the application roll 14 as described above and defines the running passage of the base-web material 18 leading from the backing roll 12 to the drive roll 28. Under this condition, the take-off roll 54 rotates smoothly following the running of the base-web material 18.

As shown, the take-off roll 54 operates to guide the base-web material 18 in the direction substantially orthogonal to the virtual plane P connecting the axis 12a of the backing roll 12 and the axis 14a of the application roll 14. As a result, in the shown embodiment, as compared with the conventional reverse roll coating device, the peripheral space at the coating material transfer point between the application roll 14 and the baseweb material 18 is reduced by about one half.

The damping section 52 includes a touch roll 58 having a rotation axis 58a parallel to the axis 12a of the backing roll 12. The touch roll 58 is arranged adjacently to the baseweb material running passage between the backing roll 12 and the take-off roll 54, and has a portion of the cylindrical outer peripheral surface 60 thereof in contact with the reverse surface 18b of the running base-web material 18. In the process, the touch roll 58 preferably lightly contacts the base-web material 18 to such a degree as not to substantially change the running passage of the base-web material 18 defined by the take-off roll 54. Even such a light contact of the touch roll 58 can effectively attenuate the vibration, which may be caused by the running base-web material 18.

The touch roll 58 may not have an exclusive drive source but may be configured to smoothly rotate following the running of the base-web material 18. Once the base-web material 18 slides on the outer peripheral surface 60 of the touch roll 58, however, the reverse surface 18b of the base-web material 18 may be scraped. Such a scrape is required to be eliminated depending on the applications of the base-web material 18. In such a case, the touch roll 58 is advantageously rotationally driven at the same outer peripheral surface speed (tangential speed) as the running speed of the base-web material 18.

As described above, with the coating device 10, the coating layer 26 can be formed on the base-web material 18 while controlling the film thickness with high accuracy regardless of the amount of the coating material supplied to the application roll 14 or the corresponding magnitude of the thickness of the coating layer 26. Further, with the coating device 10, the pressure exerted on the coating material 24 at the coating material transfer point between the application roll 14 and the base-web material 18 is substantially opened to the surrounding atmosphere. Even in the case where the base-web material 18 has irregular thickness, therefore, the thickness of the coating layer 26 can be equalized free of the effect of the thickness irregularities.

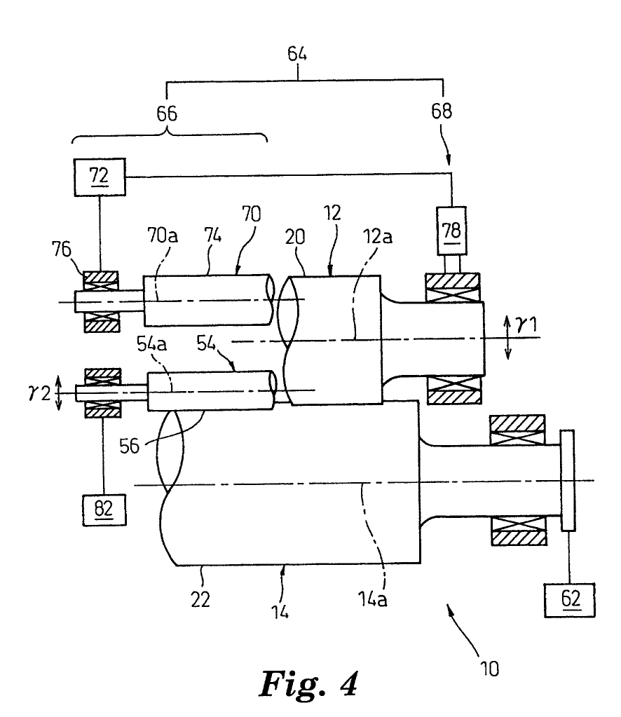

In the coating device 10, the thickness of the coating layer 26 formed on the surface of the base-web material 18 can be controlled by the ratio of the outer peripheral surface speed (tangential speed) between the backing roll 12 and the application roll 14, the interval between the outer peripheral surfaces 20 and 22 of the rolls 12 and 14, respectively, and the pressure imparted to the base-web material 18 from the rolls 12, 14. In view of this, the coating device 10 is advantageously equipped with a rotational speed control mechanism for controlling the rotational speed of the application roll 14 within the desired range, as shown in FIG. 4.

The rotational speed control mechanism 62 includes a well-known servo mechanism, for example, and is adapted to control the outer peripheral surface speed (absolute value) of the application roll 14 in the range of, say, 80% to 200%, preferably 100% to 130% or more preferably 105% to 110% of the running speed (absolute value) of the base-web material 18. By controlling the rotational speed of the application roll 14 in this range, the thickness of the coating layer 26 can be properly controlled in accordance with the properties such as the viscosity and the surface tension of the coating material 24, while at the same time making it possible to adjust the quality (thickness uniformity, surface smoothness, absence of defects, etc.) of the coating layer 26.

Further, the coating device 10 advantageously includes, as shown in FIG. 4, a pressure adjusting mechanism 64 for adjusting the interval between the outer peripheral surface 20 of the backing roll 12 and the outer peripheral surface 22 of the application roll 14 and the pressure imparted on the base-web material 18 from the backing roll 12 and the application roll 14 between the same rolls 12 and 14.

The pressure imparted by the backing roll 12 and the application roll 14 on the base-web material 18 running between the same rolls 12 and 14 is determined by the shortest distance between the outer peripheral surfaces 20, 22 of the rolls 12, 14 and the thickness of the base-web material 18. In the case where this pressure is higher than the proper value, both the backing roll 12 and the application roll 14 rotated with the running base-web material 18 held therebetween are heated by the friction between the surface 18a of the base-web material and the outer peripheral surface 22 of the application roll 14 moving in opposite directions. This gives rise to the thermal expansion of the rolls 12, 14 thereby further increasing the pressure. As a result, the tension exerted longitudinally of the base-web material 18 downstream of the coating material transfer point gradually increases. In such a case, the thermal expansion of the application roll 14 changes the shape of the coating gap 44 between the outer peripheral surface 22 of the application roll 14 and the nozzle end face 38 of the die nozzle 36, and therefore the amount of the coating material supplied to the application roll 14 changes, with the result that the thickness of the coating layer 26 on the base-web material 18 becomes uneven longitudinally of the base-web material. In the case where the pressure imparted on the running base-web material 18 from the rolls 12, 14 is lower than the proper value, on the other hand, the transfer of the coating material 24 from the outer peripheral surface 22 of the application roll 14 to the surface 18a of the base-web material 18 becomes insufficient, so that a portion of the coating material 24 is left on the application roll 14. In this case, too, the thickness of the coating layer 26 on the base-web material 18 becomes uneven.

For assuring a proper range of pressure imparted from the backing roll 12 and the application roll 14 on the base-web material 18, both the tension exerted longitudinally of the base-web material 18 downstream of the coating material transfer point and the presence or absence of the coating material 24 left on the application roll 14 are advantageously monitored constantly. For this reason, the coating device 10 comprises a pressure adjusting mechanism 64 including a tension monitor section 66 for monitoring the tension imposed longitudinally of the base-web material 18 downstream of the backing roll 12 and the application roll 14 in the direction of web run and a roll position adjusting section 68 for adjusting the relative positions of the backing roll 12 and the application roll 14 in accordance with the change in the tension monitored by the tension monitor section 66 (FIG. 4).

The tension monitor section 66 includes a tension measuring roll 70 having a rotation axis 70a parallel to the axis 12a of the backing roll 12 and a control unit 72 for arithmetically processing the result of measurement of the tension measuring roll 70 and issuing an operating instruction to the roll position adjusting section 68. The tension measuring roll 70 is arranged adjacently to the running passage of the base-web material between the take-off roll 54 and the drive roll 28 (FIG. 1) and has a portion of the cylindrical outer peripheral surface 74 thereof in contact with the reverse surface 18b of the running base-web material 18. The tension measuring roll 70 includes a detector 76 for continuously detecting the external force exerted radially on the bearing section thereof. The radial load value detected by the detector 76 is arithmetically processed in the control unit 72 as a tension imposed longitudinally of the base-web material 18 at a particular moment. The tension measuring roll 70, like the touch roll 58 described above, either rotates following the running of the base-web material 18 or is rotationally driven at the same outer peripheral surface speed as the running speed of the base-web material 18.

The roll position adjusting section 68 includes a moving unit 78 for moving the backing roll 12 parallel in the direction (along the shown arrow γ1) orthogonal to the axis 12a of the backing roll 12 and parallel to the virtual plane P (FIG. 1) described above. In compliance with the instruction from the control unit 72, the moving unit 78 moves the backing roll 12, while keeping it rotatable, toward or away from the application roll 14, thereby adjusting the interval between the outer peripheral surface 20 of the backing roll 12 and the outer peripheral surface 22 of the application roll 14.

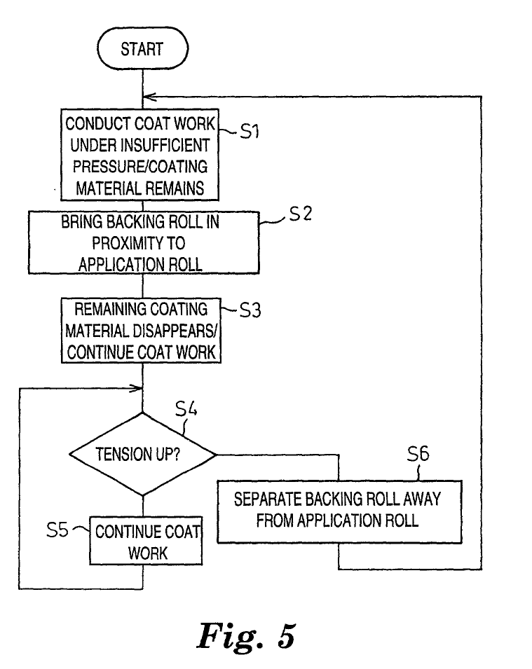

An example of the process for adjusting the pressure exerted by the pressure adjusting mechanism 64 having the above-mentioned configuration will be explained with reference to FIG. 5.

First, the positions of the backing roll 12 and the application roll 14 are set to initial positions at which the pressure imposed on the base-web material 18 from the rolls 12, 14 is somewhat insufficient, and the coating device 10 is activated thereby to start the coat work on the base-web material 18. If the coat wok is continued under this condition, the transfer of the coating material 24 from the outer peripheral surface 22 of the application roll 14 to the surface 18a of the base-web material 18 is insufficient, and therefore a portion of the coating material 24 remains on the application roll 14 (step S1). In the case where it is visually detected that the coating material 24 remains on the application roll 14, for example, the backing roll 12 is moved in parallel toward the application roll 14 by operating the roll position adjusting section 68 (step S2). At the position where the remaining portion of the coating material 24 on the application roll 14 disappears, the movement of the backing roll 12 is completed and the coat work is continued under that condition (step S3).

From the time when the coating device 10 begins to operate, the tension monitor section 66 continues to monitor the tension imposed longitudinally of the base-web material 18 downstream of the coating material transfer point. In the case where the change in tension is not detected longitudinally of the base-web material 18 by the tension monitor section 66 after step S3, it is determined that the pressure imparted on the baseweb material 18 from the rolls 12, 14 is optimal (step S4), and the coat work is continued under that condition (step S5). Also after that, the tension monitor section 66 continues to monitor the tension longitudinally of the base-web material 18 until the end of the coat work.

In the case where the gradual increase of the tension longitudinal of the base-web material 18 is detected for over a predetermined length of time, for example, by the tension monitor section 66 after step S3, it is determined that the pressure imparted by the rolls 12, 14 on the base-web material 18 is excessive (step S4), and the backing roll 12 is moved parallel away from the application roll 14 by activating the roll position adjusting section 68 (step S6). After resetting the backing roll 12 to the state of step S1, the coat work of and after step S2 is continues until the optimum pressure is achieved. In the coating device 10, as shown in FIG. 1, a blade 80 for scraping off the coating material remaining on the application roll 14 is arranged in proximity to the application roll 14.

In the coating device 10, preferably, the outer peripheral surface 22 of the application roll 14 is formed of a high hardness metal material that can be machined with high accuracy and the portion of the backing roll 12 having the desired thickness including at least the outer peripheral surface 20 is formed of an elastic material such as rubber. In such a case, the pressure imparted from the backing roll 12 and the application roll 14 on the base-web material 18 is often optimized when the outer peripheral surface 20 of the backing roll 12 and the outer peripheral surface 22 of the application roll 14 are in such relative positions to each other that the outer peripheral surface 20 of the backing roll 12 is elastically deformed slightly by being pressed by the outer peripheral surface 22 of the application roll 14. This is by reason of the fact that the factors on the part of the backing roll 12 that may affect the thickness control of the coating layer 26 such as the run-out of the backing roll 12 in rotation and the cylindricity error of the outer peripheral surface 20 of the backing roll 12 can be offset by the elastic deformation of the outer peripheral surface 20 of the backing roll 12. The optimum value of the depth of the concave deformation of the outer peripheral surface 20 of the backing roll 12 deformed under the pressure of the application roll 14, like the optimum value of the pressure imparted on the base-web material 18 from the rolls 12, 14, is dependent on the properties such as viscosity and surface tension of the coating material 24, and can be achieved by the aforementioned pressure adjusting process using the pressure adjusting mechanism 64.

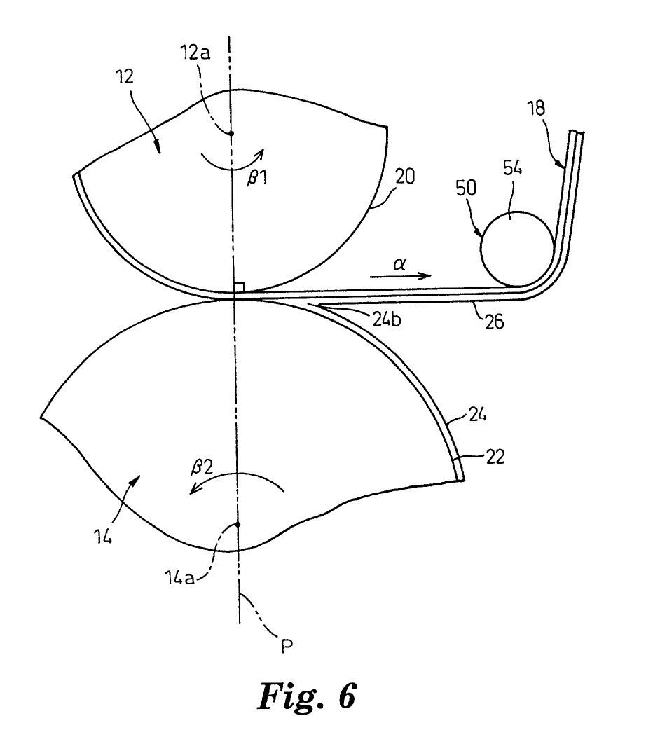

In the case where the outer peripheral surface 20 of the backing roll 12 has such a stiffness as not to be easily deformed by being pressed by the outer peripheral surface 22 of the application roll 14, it is recommended that the take-off roll 54 of the separating section 50 be arranged at a position where the base-web material 18 is guided in the direction at right angles to the virtual plane P described above. With this configuration, as shown in FIG. 6, the base-web material 18 is in contact with the outer peripheral surface 22 of the application roll 14 on the virtual plane P, and at the same time, separated from the backing roll 12 without being wound on either the roll 12 or 14 downstream of the contact point with the outer peripheral surface 22 of the application roll 14 in the direction of web run. Under this condition, the peripheral space at the coating material transfer point between the application roll 14 and the base-web material 18 is narrowed most thereby to minimize the meniscus of the fluid coating material portion 24b flowing at the coating material transfer point.

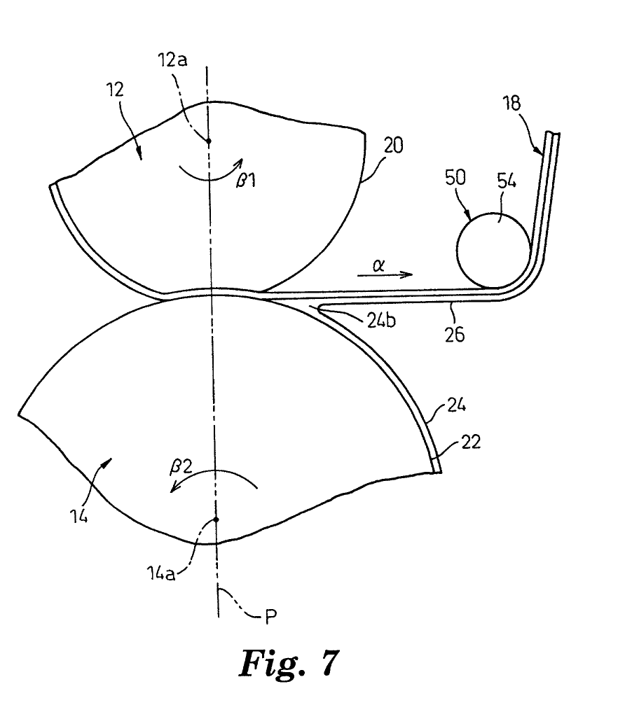

In the case where the portion having the desired thickness of the backing roll 12 including at least the outer peripheral surface 20 thereof is formed of an elastic material such as rubber as described above, on the other hand, the concave deformation of the outer peripheral surface 20 of the backing roll 12 under the pressure of the outer peripheral surface 22 of the application roll 14 causes, as shown in FIG. 7, the base-web material 18 to come into contact with the outer peripheral surfaces 20, 22 of the rolls 12, 14 over a length corresponding to the range of concave deformation of the outer peripheral surface 20 of the backing roll 12. Consequently, the position where the base-web material 18 is separated from the outer peripheral surface 22 of the application roll 14 is displaced downstream of the virtual plane P in the direction of web run. In such a case, assuming that the take-off roll 54 of the separating section 50 is located at a position where the baseweb material 18 is guided in the direction at right angles to the virtual plane P as shown, as compared with the state of FIG. 6 where the outer peripheral surface 20 of the backing roll 12 is not deformed, the peripheral space at the coating material transfer point between the application roll 14 and the base-web material 18 is expanded thereby to enlarge the meniscus of the fluid coating material portion 24b. As a result, a rib-shaped defect is more liable to develop on the surface of the coating layer 26 formed on the base-web material 18.

In either state of FIG. 6 or 7, the base-web material 18 is separated from the outer peripheral surface 22 of the application roll 14 and forms a fluid coating material portion 24b at the same position where it is separated from the outer peripheral surface 20 of the backing roll 12. Thus, the minuscule unevenness such as dust and dirt on the outer peripheral surface 20 of the backing roll 12 and the run-out of the backing roll 12 in rotation may affect the thickness uniformity of the coating layer 26 formed on the baseweb material 18.

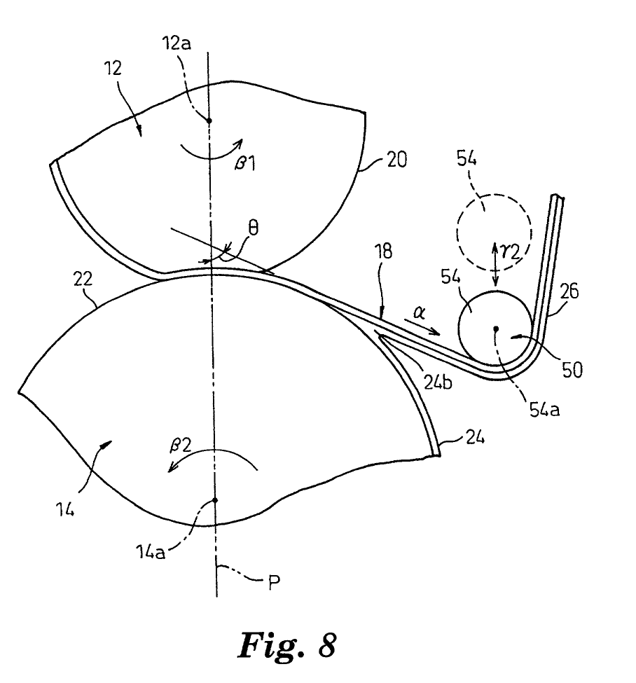

In view of this, the separating section 50 of the coating device 10 advantageously includes a running angle adjusting mechanism 82 for adjusting the running angle of the base-web material 18 with respect to the virtual plane P connecting the axis 12a of the backing roll 12 and the axis 14a of the application roll 14, as shown in FIGS. 4 and 8. In the shown embodiment, the running angle adjusting mechanism 82 functions in such a manner as to move the take-off roll 54 in the direction at right angles to the axis 54a and parallel to the virtual plane P (along arrow γ2 shown). The running angle of the base-web material 18 is defined as an angle θ that the base-web material 18 running along the running passage defined by the take-off roll 54 forms to the virtual plane P.

The running angle adjusting mechanism 82 operates in such a manner that the base-web material 18 in contact with the outer peripheral surface 22 of the application roll 14 over the length corresponding to the range of concave deformation of the outer peripheral surface 20 of the backing roll 12 is wound on the outer peripheral surface 22 of the application roll 14 over the desired length downstream of the position, in the direction of web run, where the base-web material 18 is separated from the outer peripheral surface 20 of the backing roll 12 (FIG. 8). In other words, the running angle adjusting mechanism 82 moves the take-off roll 54 parallel in the direction γ2 in such a manner as to adjust the running angle of the base-web material 18 in the range of not more than 90°. As a result, the base-web material 18 is separated along the tangential direction from the outer peripheral surface 22 of the application roll 14 at a distant position downstream of the concave deformation range of the outer peripheral surface 20 of the backing roll 12 in the direction of web run.

Under this condition, the peripheral space at the coating material transfer point between the application roll 14 and the base-web material 18 is narrowed most as in the state shown in FIG. 6, thereby minimizing the meniscus of the fluid coating material portion 24b flowing at the coating material transfer point. Thus, even in the state of the outer peripheral surface 20 of the backing roll 12 elastically deformed under the pressure of the outer peripheral surface 22 of the application roll 14, the rib- shaped surface defect of the coating layer 26 formed on the base-web material 18 is eliminated. In addition, the base-web material 18 is separated from the outer peripheral surface 22 of the application roll 14 at a distant position downstream of the outer peripheral surface 20 of the backing roll 12 in the direction of web run, and therefore the minuscule unevenness of the outer peripheral surface 20 of the backing roll 12 and the run-out of the backing roll 12 in rotation are effectively prevented from affecting the thickness uniformity of the coating layer 26.

The required range of the running angle θ of the base-web material 18 regulated by the running angle adjusting mechanism 82 described above is dependent on the diameter of the backing roll 12 and the application roll 14 and the depth of the concave deformation of the outer peripheral surface 20 of the backing roll 12 deformed under the pressure of the application roll 14. In the case where the coat work is carried out with the outer peripheral surface 20 of the backing roll 12 concavity deformed to the optimum depth of 0 mm to 0.2 mm corresponding to the properties of the coating material 24 using the backing roll 12 having a diameter of 150 mm and the application roll 14 having a diameter of 300 mm, for example, the required adjusting range of the base-web material running angle θ is given approximately as 88°≦θ≦90°.

As far as the running angle adjusting mechanism 82 of the separating section 50 is effectively used, the effect that the minuscule unevenness of the outer peripheral surface 20 of the backing roll 12 or the run-out of the backing roll 12 in rotation might otherwise have on the thickness of the coating layer 26 can be eliminated by moving the take-off roll 54 downward and winding the desired length of the base-web material 18 on the outer peripheral surface 22 of the application roll 14 also after the separation from the outer peripheral surface 20 of the backing roll 12 even in the case where the outer peripheral surface 20 of the backing roll 12 is free of a concave deformation as shown in FIG. 6, for example. Also, in the case where the coating material 24 exhibiting a low surface tension against the metal material of the application roll 14 is used, for example, the coating layer 26 of the desired thickness can be formed with high accuracy on the base-web material 18 by moving the take-off roll downward by a required length even when no pressure is imparted with the base-web material 18 not held between the rolls 12, 14.

When moving the take-off roll 54 parallel in the direction γ2 by the running angle adjusting mechanism 82, the touch roll 58 of the damping section 52 is also required to be moved in the same parallel direction. For this purpose, the damping section 52 of the coating device 10 desirably includes a touch roll moving mechanism not shown. In such a case, the touch roll moving mechanism is advantageously so configured as to move the touch roll 58 by the distance corresponding to the distance covered by the take-off roll 54 in collaboration with the running angle adjusting mechanism 82.

With the coating device 10, in order to carry out the continuous automatic coat work over a long length of time, a plurality of the base webs 18 of a predetermined length may be joined longitudinally. In such a case, the joints of the base webs 18 are twice as thick as the remaining portions and are not smoothly passed easily between the backing roll 12 and the application roll 14 at the coat work position. For suspending the coat work temporarily when each joint of the base-web material 18 passes between the backing roll 12 and the application roll 14, therefore, the coating device 10 further advantageously comprises a backing roll moving mechanism for moving the rotating backing roll 12 in parallel to the rotating application roll 14. The backing roll moving mechanism can be configured with, for example, the roll position adjusting section 68 of the pressure adjusting mechanism 64 shown in FIG. 4.

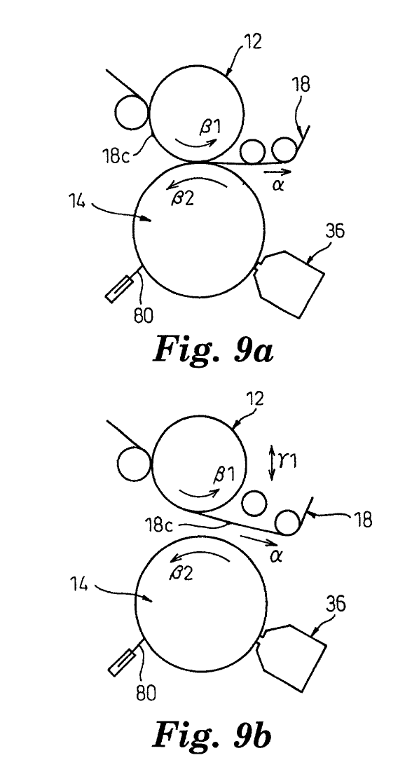

In the case where a web joint 18c approaches the mutually opposed area between the backing roll 12 and the application roll 14 during the normal coat work shown in FIG. 9(a), for example, a sensor not shown senses it and activates the moving unit 78 of the roll position adjusting section 68. As a result, the backing roll 12 can be moved parallel in the direction (γ1) away from the application roll 14 without stopping the running of the base-web material 18 and the rotation of the application roll 14 (FIG. 9(b)). Under this condition, the web joint 18c can pass between the backing roll 12 and the application roll 14 without interfering with the rolls 12, 14. After that, the moving unit 78 is activated again thereby to return the backing roll 12 to the position for normal coat work. By the way, the coating material that has been left on the outer peripheral surface 22 of the application roll 14 while passing the web joint 18c is positively removed by the blade 80 before reaching the position of the die nozzle 36.

With this configuration, during the suspension of the coat work to pass the web joint 18c, the coating gap 44 (FIG. 3) affecting the amount of coating material supplied to the application roll 14 remains unchanged at all. Before and after passage of the web joint 18c, therefore, the accuracy of the coating layer formed on the base-web material 18 can be maintained with comparative ease. This operation of the backing roll 12 is sufficiently the reciprocal motion over a predetermined distance for a comparatively short time, and therefore can be realized by a reciprocating section having a simple structure arranged independently of the moving unit 78 of the roll position adjusting section 68.

In the coating device and method, according to this invention, the separating section is added to the configuration of the conventional reverse roll coating device, so that a coating layer of a very superior quality (uniform thickness, smooth surface, absence of defects, etc.) can be formed on the surface of the base-web material regardless of the magnitude of the thickness of the coating layer required of the product. Thus, like in the coating device 10 described above, the amount of the coating material supplied to the application roll 14 is advantageously controlled with high accuracy by installing the die nozzle 36 in the coating material supply section 16. As far as the amount of the coating material supplied can be maintained at the required level, however, the coating material supply section can be equipped with any of various structures of supply section other than the die nozzle.

In the case where the coating material supply section 16 is equipped with the die nozzle 36, various modifications can be employed as described below.

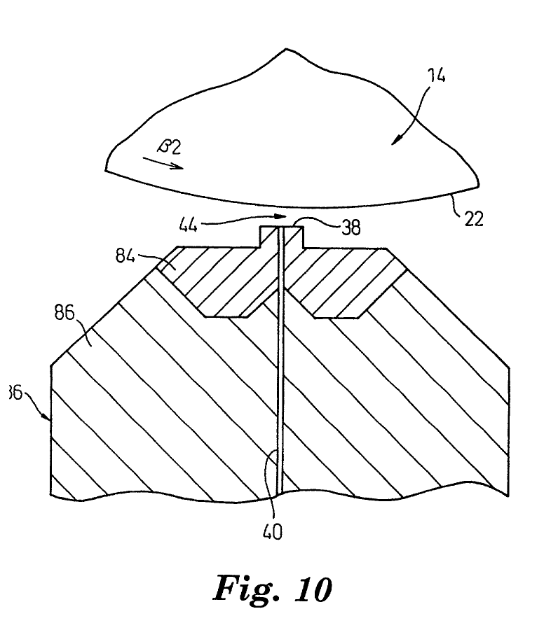

As shown in FIG. 10, for example, the die nozzle 36 can be configured with a first portion 84 including at least a nozzle end face 38 and a second portion 86 adjoining the first portion 84, integrally coupled to each other. By fabricating the first portion 84 and the second portion 86 of materials having different coefficients of linear expansion, the die nozzle can be advantageously formed of a structure like a bimetal.

With this configuration, the desired displacement can be generated in the first portion 84 and the second portion 86 due to the difference of expansion coefficient by heating or cooling the die nozzle 36 to the desired temperature from the machining temperature. In this way, the nozzle end face 38 associated with the first portion 84 can be delicately deformed with the result that the shape of the coating gap 44 can be finely adjusted. According to this configuration, the deteriorated geometric accuracy of the coating gap 44 attributable, for example, to the low machining accuracy and the low assembly accuracy, the difference between the temperature at the working place and the operating reference temperature of the die nozzle 36, etc. can be corrected by detailed temperature control of the die nozzle 36 thereby to improve the thickness uniformity of the coating material 24 supplied in the form of a wet coating layer to the application roll 14.

Tungsten carbide and stainless steel are example candidates for a suitable material of the first portion 84 and the second portion 86 of the die nozzle 36. Especially, the first portion 84 including the nozzle end face can be made of, in addition to tungsten carbide, any of various hard material s capable of high-precision grinding, such as different types of stainless steel, carbon steel and ceramics having a different coefficient of linear expansion than the second portion 86. In the case where tungsten carbide and the stainless steel are employed for the first portion 84 and the second portion 86, respectively, the volume ratio between the two is preferably about 1:8 to 1:10 especially taking the material cost into consideration. Also, various means such as bolting, pin driving, brazing and bonding can be employed for integrally coupling the first portion 84 and the second portion 86 to each other.

With this configuration, though not shown, temperature control means for controlling the temperature of the die nozzle 36 itself is advantageously built in. As such a temperature control means, a flowing water conduit is installed adjacently to the first portion 84 of the die nozzle 36, and water, oil, ethylene glycol solution or the like medium regulated to the desired temperature is supplied to the flowing water conduit from an external source and circulated in the conduit.

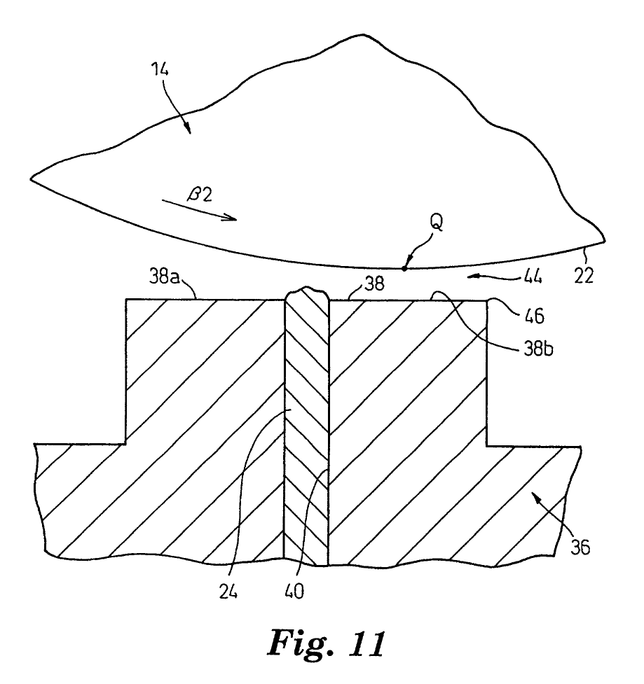

As shown in FIG. 11, the nozzle end face 38 of the die nozzle 36 can be configured to be located in most proximity to the outer peripheral surface 22 of the application roll 14 at a predetermined position (position Q in the drawing) inside the second surface portion 38b defined between the opening of the coating material supply passage 40 and the die lip 46 at the downstream end in the direction of rotation of the application roll. With these relative positions, when the coating gap 44 is reduced to reduce the amount of coating material supplied, the die lip 46 machined with especially high accuracy can be prevented from breaking even in the case where the nozzle end face 38 comes into contact with, for example, foreign matter mixed in the coating material 24 or comes into contact with the outer peripheral surface 22 of the application roll 14 due to a low machining accuracy or a low assembly accuracy during the coat work.

With the coating device 10 shown in FIGS. 1 to 4, the coat work has been conducted under the following conditions:

Minimum size of coating gap 44=20 μm

Straightness of die lip 46=±0.2 μm

Rotation run-out of application roll 14=±0.5 μm

Rotation run-out of backing roll 12=5 μm

Concave deformation depth of backing roll outer peripheral surface 20=30 μm

Travel speed of base-web material 18=40 m/min

Thickness of base-web material 18=75 μm±2.25 μm (thickness

irregularity=3%)

Solid component concentration of coating material 24=10%

As a result, the following coating layer 26 has been formed on the surface 18a of the base-web material 18.

Wet film thickness=10 μm (required coated film thickness accuracy=±3%)

Solid component density=1.0 g/cm³

Wet component density=1.0 g/cm³

The effect that the thickness irregularity of the base-web material 18 has on the thickness uniformity of this coating layer 26 has not been substantially observed.

As apparent from the foregoing description, according to this invention, there is provided a coating device for forming a coating layer continuously on the surface of a running base web, in which a coating layer of uniform thickness can be formed on the surface of the base-web material steadily with high accuracy without regard to the required magnitude of the coating layer thickness over a long length of time without being substantially affected by the thickness irregularity of the base-web material itself.

Similarly, in the coating method according to the invention, it is possible to form a coating layer with a uniform thickness on the surface of the base-web material steadily with high accuracy without regard to the required magnitude of the coating layer thickness over a long length of time without being substantially affected by the thickness irregularity of the base-web material itself.

What is claimed is:

1. A coating device comprising:
a backing roll rotatable while carrying on an outer surface thereof a running base-web material;
an application roll arranged close and parallel to said backing roll and rotatable in the same direction as a rotating direction of said backing roll while coming into contact on an outer surface thereof with the base-web material running along said backing roll;
a coating material supply section for supplying a coating material on said outer surface of said application roll; and
a separating section arranged downstream of said backing roll and said application roll as seen in a web running direction, said separating section capable of separating the running base-web material from said outer surface of said backing roll at a position inside a mutually opposed region of said backing roll and said application roll;
wherein the coating material continuously supplied from said coating material supply section to said outer surface of the rotating application roll is transferred to a surface of the running base-web material so as to continuously form a coating layer with a predetermined thickness.

2. A coating device as set forth in claim 1, wherein said separating section acts to direct the base-web material in a direction generally orthogonal to a virtual plane involving a rotation axis of said backing roll and a rotation axis of said application roll.

3. A coating device as set forth in claim 1, wherein said separating section includes a running-angle adjusting mechanism for adjusting a running angle of the base-web material relative to a virtual plane involving a rotation axis of said backing roll and a rotation axis of said application roll.

4. A coating device as set forth in claim 3, wherein said separating section includes a take-off roll arranged parallel to said backing roll and rotatable while carrying on an outer surface thereof the running base-web material, and wherein said running-angle adjusting mechanism acts to move said take-off roll while maintaining a parallelism thereof so as to adjust the running angle of the base-web material.

5. A coating device as set forth in claim 1, further comprising a damping section arranged between said backing roll and said separating section, said damping section capable of coming into contact with the running base-web material to damp a vibration of said base-web material.

6. A coating device as set forth in claim 5, wherein said damping section includes a touch roll arranged parallel to said backing roll and rotatable while touching the running base-web material.

7. A coating device as set forth in claim 1, further comprising a pressure adjusting mechanism for adjusting a pressure applied to the base-web material from said backing roll and said application roll at a location between said backing roll and said application roll.

8. A coating device as set forth in claim 7, wherein said pressure adjusting mechanism includes a tension monitoring section for monitoring a tension applied longitudinally on the base-web material at a downstream side of said backing roll and said application roll as seen in a web running direction, and a roll-position adjusting section for adjusting a relative position of said backing roll to said application roll so as to correspond to a fluctuation of the tension monitored by said tension monitoring section.

9. A coating device as set forth in claims 1, further comprising a backing roll moving mechanism for moving said rotating backing roll relative to said rotating application roll while maintaining a parallelism thereof.

10. A coating device as set forth in claim 1, further comprising a driving section arranged downstream of said backing roll and said application roll as seen in a web running direction and causing the base-web material to run in a longitudinal direction thereof at a predetermined speed, and a nip roll arranged upstream of said backing roll and said application roll as seen in a web running direction and rotatable while holding the base-web material running due to an operation of said driving section between said nip roll and said backing roll.

11. A coating device as set forth in claim 1, wherein said coating material supply section comprises a die nozzle which includes a nozzle end face opposed to said outer surface of said application roll and a supply passage communicating with said nozzle end face to continuously supply a coating material in an extruding manner on said nozzle end face through said supply passage, and wherein the coating material is measured between said outer surface of said rotating application roll and said nozzle end face of said die nozzle, so as to be continuously supplied in the form of a coating layer with a predetermined thickness on said outer surface of said application roll.

12. A coating device as set forth in claim 11, wherein said die nozzle includes in an integral manner a first portion involving at least said nozzle end face and a second portion adjacent to said first portion, said first portion being made of a material with a coefficient of thermal expansion different from that of a material of said second portion.

13. A coating device as set forth in claim 11, wherein said nozzle end face of said die nozzle is located closest to said outer surface of said application roll at a predetermined position inside a surface area defined between a downstream end as seen in an application-roll rotating direction and said supply passage.

14. A coating method comprising:
having a base-web material carried on an outer surface of a rotatable backing roll;
arranging a rotatable application roll close and parallel to said backing roll so as to come into contact on an outer surface of said application roll with the base-web material carried on said backing roll;
having the base-web material run continuously in one direction so as to rotate said backing roll in one direction;
separating the running base-web material from said outer surface of said backing roll at a position inside a mutually opposed region of said backing roll and said application roll;
rotating said application roll in the same direction as a rotating direction of said backing roll; and
continuously supplying a coating material on said outer surface of the rotating application roll, so that the coating material is transferred to a surface of the running base-web material so as to continuously form a coating layer with a predetermined thickness on the surface.

15. A coating method as set forth in claim 14, further comprising a step of having the running base-web material brought into contact with an object at a location downstream of said backing roll as seen in a web running direction, so as to damp a vibration of the base-web material.

16. A coating device comprising:
a backing roll rotatable while carrying on an outer surface thereof a running base-web material;
an application roll arranged close and parallel to said backing roll and rotatable in the same direction as a rotating direction of said backing roll while coming into contact on an outer surface thereof with the base-web material running along said backing roll; and
a die nozzle including a nozzle end face opposed to said outer surface of said application roll and a supply passage communicating with said nozzle end face to continuously supply a coating material in an extruding manner on said nozzle end face through said supply passage;
wherein the coating material is measured between said outer surface of said rotating application roll and said nozzle end face of said die nozzle, so as to be continuously supplied in the form of a coating layer with a predetermined thickness on said outer surface of said application roll; and
wherein the coating material supplied to said outer surface of said application roll is transferred to a surface of the running base-web material so as to continuously form a coating layer with a predetermined thickness.
